(19) United States
(12) Patent Application Publication
(10) Pub. No.: US 2011/0155935 A1
(43) Pub. Date: Jun. 30, 2011

(54) CONTROL VALVE FOR A COOLING SYSTEM

(76) Inventor: Morten Morkholt, Silkeborg (DK)

(21) Appl. No.: 13/062,051

(22) PCT Filed: Aug. 20, 2009
(86) PCT No.: PCT/DK2009/050206

§ 371 Date: Mar. 3, 2011

(30) Foreign Application Priority Data
Sep. 4, 2008 (DK) PA 2008 01229

(51) Int. Cl. F16K 31/02

(52) U.S. Cl. 251/129.11

(57) ABSTRACT

A control valve for a cooling system for hydraulic fluid in hydraulic control systems in wind power turbine or similar control systems comprising a valve member. An electrical powered modulating rotary actuator oscillates with predominantly constant velocity in a valve housing or manifold, wherein the valve housing or manifold comprises a main channel, a control channel and channels. The valve member is a cylindrical member with a side recess with an adjustable shape which is adjusted in accordance with a desired control characteristic of the control valve. The electrical modulating rotary actuator executes oscillating or swinging movements between extreme predetermined angular positions. The control valve is for use in cooling systems for hydraulic fluid in hydraulic control systems in wind power turbine or similar control systems, where the importance of precise and reliable temperature control is significant.

### BACKGROUND OF THE INVENTION

1. Field of the Invention

The present invention relates to a control valve for a cooling system.

2. Description of the Prior Art

In connection with the temperature control in cooling systems for hydraulic fluid in hydraulic control systems in wind power turbines, it is very important to have a precise and reliable temperature control system.

WO 03100950 A1 discloses an electric motor driven actuator comprising an electronically switchable direct-current synchronous motor and a device working with position sensors for contactless detection of the position of the rotor of the motor. The inventive actuator is especially suitable for directly driving the final control element of a valve arrangement in a motor vehicle, preferably in an engine cooling circuit or as a throttle valve. High positional accuracy is obtained by virtue of the fact that the position sensors are spatially associated with a magnetic field device for the magnetic field of the rotor.

### SUMMARY OF THE INVENTION

The present invention provides an improved control valve of the above-mentioned type which by simple provisions provides a control valve for use in cooling systems for use in cooling systems for hydraulic fluid in hydraulic control systems in wind power turbine or similar control systems in which precise and reliable temperature control is significant.

According to the invention, the control valve has a valve housing or manifold comprising a main channel, a control channel and a number of measuring channels, a valve member with cylindrical piston member provided with a side recess. The shape of the side recess is adjusted in accordance with the desired control characteristic of the control valve, and an electrical modulating rotary actuator executes oscillating or swinging movements between extreme predetermined angular positions of the valve member.

By means of simple provisions a control valve is provided for use in cooling systems for hydraulic fluid, in hydraulic control systems, in wind power turbine or similar control systems, where the importance of precise and reliable temperature control is significant.

By oscillating angular movement, the valve actuator mixes the two temperatures of the medias to a certain controlled inlet temperature for, by

In an alternative embodiment, the control valve according to the invention includes the recess of the cylindrical piston member having mutually parallel sides, which at a distance from each other extend perpendicular to a center plane through the cylindrical member.

The control valve according to the invention may include electrical modulating rotary actuator performing oscillating or swinging movements between extreme points with a mutual angular difference of about 90°-180°.

In a first embodiment, the control valve according to the invention may include the electrical modulating rotary actuator executing oscillating or swinging movements between extreme points with a mutual angular difference of about 90°.

Alternatively, the control valve according to the invention may include the electrical modulating rotary actuator executing oscillating or swinging movements between extreme points with a mutual angular difference of about 180°.

### BRIEF DESCRIPTION OF THE DRAWINGS

The invention is described in more detail in the following with reference to the drawing—in which:

FIG. 1 shows a plane view [-] which is partly in section [-] of an embodiment for a control valve according to the invention;

FIG. 2 shows a plane sectional view through the channels of valve housing or manifold of the control valve of FIG. 1;

FIG. 3 shows in two views cylindrical piston members with a triangular-shaped side recess (to the left hand side of FIG. 3) and with a square side recess (to the right hand side of FIG. 3);

FIG. 4 shows a plane view respectively illustrating comparison graphs illustrating valve members with a triangular (V-shaped) recess and square recess;

FIG. 5 shows a diagram of a complete liquid cooling system for the hydraulic liquid for a hydraulic control system, by way of example, for a wind power turbine comprising a control valve according to the invention;

FIG. 6 shows in a side view and a top view an embodiment of an electrical modulating rotary actuator used to rotate the piston valve member of a control valve according to the invention; and

FIG. 7 shows a perspective view of an embodiment of a modified valve member comprising a cylindrical central, longitudinal channel communicating with the triangular side recess of the valve member.

### DETAILED DESCRIPTION OF THE INVENTION

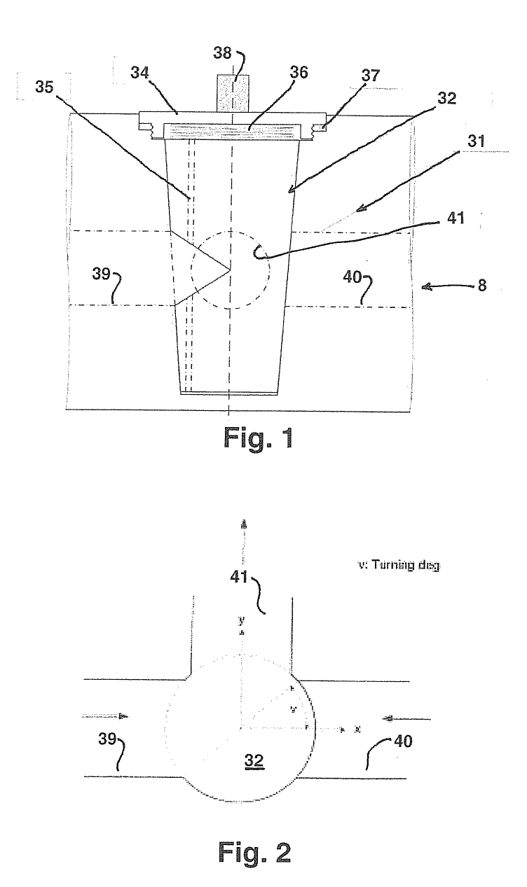

The control valve according to the invention shown in FIGS. 1 and 2 comprises a valve housing or manifold 31 provided with a central conical main channel or bore for a conical cylindrical valve member 32 communicating with manifold ports in the form of an inlet port 39 for cold liquid, a inlet port for 40 for warm liquid and a supply port 41 for mixed liquid. The dotted lines of FIG. 2 define the passage where the fluid flows from the cold inlet port 39 to the supply port 41.

The internal valve cylinder is made conical with the same slope as that of the central, main bore of the valve housing or manifold 31. In this manner it is assured that in case of wear, the valve cylinder will still be able to prevent internal leakage in the manifold. This is achieved by inserting a spring 36 in the top of the valve cylinder 32 which generates a preloaded downwards force on the valve cylinder at its seat. In case of an internal wear of the valve cylinder 32, the spring 36 on top of the valve cylinder 32 will secure that the cylinder still fits firmly at its seat.

To insure that the spring 36 always is able to make the valve cylinder fit closely in its seat, even if an internal leakage should occur, the valve cylinder is made with a balancing port 35. This way the flowing fluid will always generate the same forces on the top and the bottom of the valve cylinder 32 in opposite directions.

At the top of the valve housing or manifold 31, a top lid 34 is mounted and tightened by a ring-shaped gasket 37 with spring 36 positioned between the top of the valve cylinder 32 and the top lid 34.

In order to prevent galvanic corrosion and for obtaining important mechanical advantages such as reducing wear and friction/stick-slip etc., the valve housing or manifold 31 and also the top lid 34 can be produced from a suitable durable and wear resistant material such as sea water resistant aluminium such as by way of example EN AW 5083. The valve cylinder 32 may be produced from acid-proof stainless steel, such as by way of example AIS1316, or a suitable durable technical plastic such as PETP TX (polyethylenterephtalat) possibly comprising a small amount of PTFE (Teflon).

The conical valve member 32 is provided with a side recess 29 having a triangular shape with the pointed ends of the recess positioned in a horizontal plane along a transverse center line or axis of the valve member 32. Alternatively, the valve member 32 may be provided with a square side recess 30. By rotation of the valve member 32 with oscillating forward and backward turns by means of an electrical modulating rotary actuator 42 (FIG. 6), it is possible to obtain a precise and reliable control valve, by way of example, for controlling the temperature of the hydraulic liquid in the hydraulic control systems in wind power turbine or similar control systems, where the importance of precise and reliable temperature control is significant.

The velocity of turning of the valve member 32 forwards and backwards in the oscillating movement is rather slow such that the turning rate of the valve member 32 through 90° is in the order of 90 sec. The leakage from the control valve is very small in the order of 0.2 l/min for a flow in the order of 160 l/min. The overall flow rate of the control valve is between 100-250 l/min.

Cooling systems making use of a control valve according to the invention may be used for many different purposes such as cooling systems for frequency converters, electrical power generators, gearboxes and other similar cooling systems, where precision, durability and reliability are the key words.

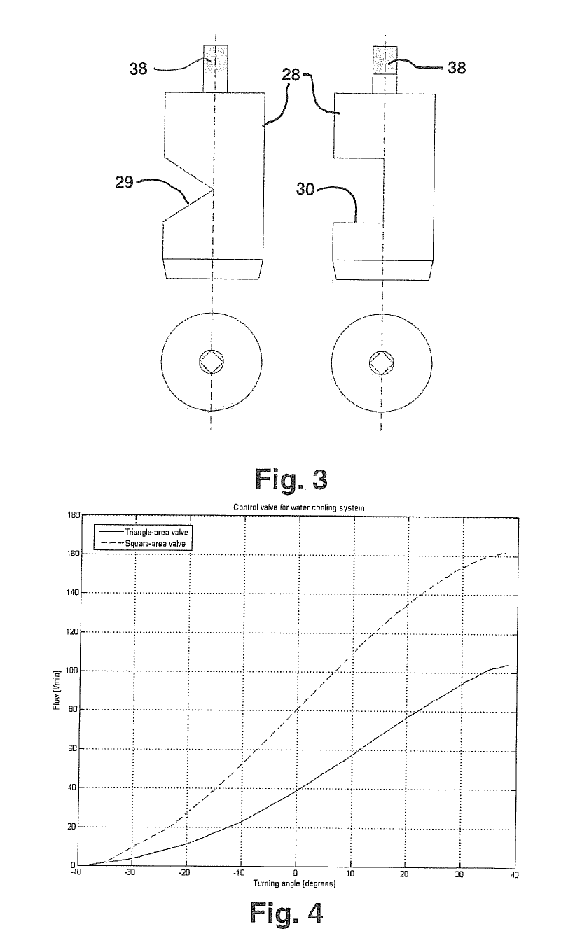

The two main principles regarding the shape of the side recesses of the valve member 32 are illustrated in FIG. 3, where in the left hand side the triangular-shaped recess 29 is shown, while the square side recess 30 is shown in the right hand side of FIG. 3.

FIG. 4 shows a comparison of the two types of control valves respectively having a triangular side recess and having square side recess.

The following conditions are common for the shown graphs or plots:

a) constant turbulent flow [l/min]
b) 52% v/v antifrogen N-water mixture. Constant temperature of 20° C.; density 1085 [kg/m³]
c) pressure drop across the valve assumed constantly 0.2 [bar]
d) flow discharge coefficient C_{d}=0.6 [-].

The two graphs show the function between the flow [l/min] over the turning angle [°] of the respective valve members.

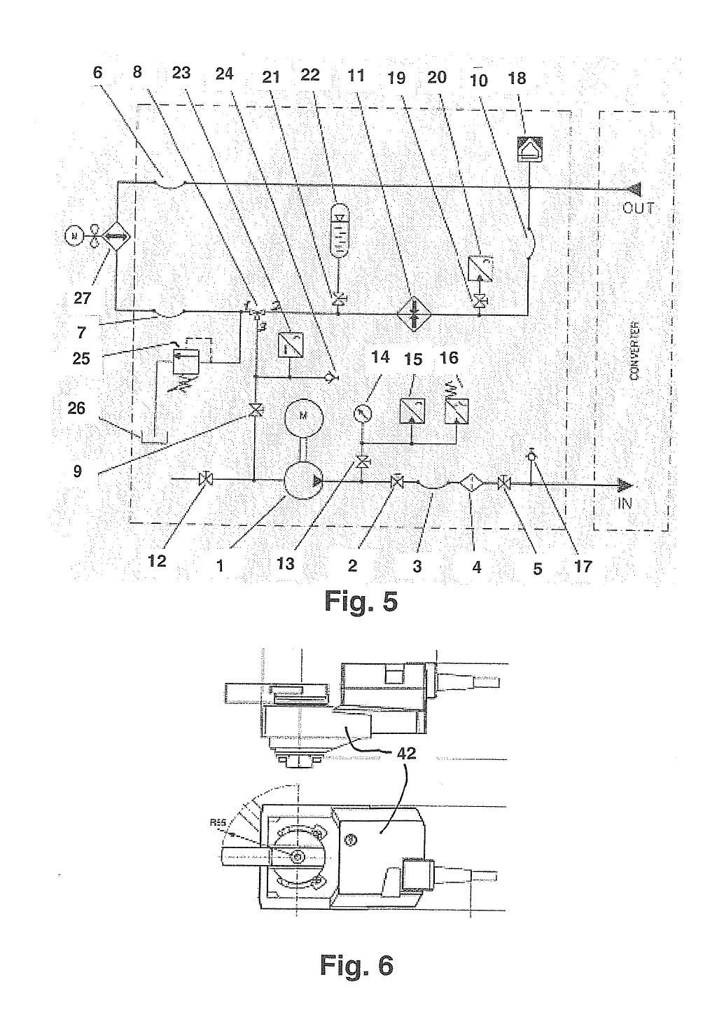

FIG. 5 illustrates, by way of example, a diagram of a complete liquid cooling system comprising a 3-way mixing or control valve 8 according to the invention with an electrical modulating rotary actuator 42.

FIG. 6 illustrates in two views the preferred type of electrical modulating rotary actuator 42. Of course it would be possible to use an electric stepping motor for the rotating of the valve member 32.

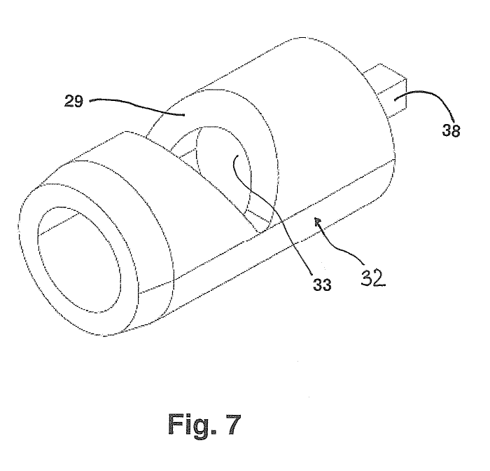

In FIG. 7 is shown an alternative embodiment of the valve member 32 with a longitudinal central bore 33 communicating with the triangular-shaped side recess 29 of the valve member 32.

### DRAWING REFERENCE NUMBERS

1: Pump (FIG. 5)
2, 5, 9, 12: Ball valves 1½ (FIG. 5)
3, 6, 7, 10: Hoses DN40 (FIG. 5)
4: Strainer, 50 micron
8: 3-way mixing control valve with actuator (2-10V) (FIG. 5)
11: Heater (FIG. 5)
13, 19, 21: Needle valves (FIG. 5)
14: Pressure gauge (FIG. 5)
15, 20: Pressure transmitter (4-20 mA) (FIG. 5)
16: Pressure switch (FIG. 5)
17, 24: Test connections (FIG. 5)
18: Air vent valve (FIG. 5)
22: Expansion tank 8 L (FIG. 5)
23: Temperature transmitter PT100 (FIG. 5)
25: Safety valve (FIG. 5)
26: Plastic bottle (Accumulation of coolant from safety valve) (FIG. 5)
27: Cooler (FIG. 5)
28: Cylindrical valve member (FIGS. 3 and 7)
29: Triangular-shaped side recess (FIGS. 1, 3 and 7)
30: Square side recess (FIG. 3)
31: Valve housing, Manifold (FIG. 1)
32: Conical cylindrical valve member (FIG. 1)
33: Central longitudinal channel (FIG. 7)
34: Top lid (FIG. 1)
35: Balance port (FIG. 1)
36: Spring (FIG. 1)
37: Gasket (FIG. 1)
38: Turning tap (squared) (FIGS. 1, 3 and 7)
39: Cold inlet (FIG. 2)
40: Warm inlet FIG. 2)
41: Supply outlet (FIG. 2)
42: Electrical modulating rotary actuator (FIG. 6)

1-7. (canceled)

8. A control valve for a system for cooling hydraulic fluid in hydraulic control systems comprising a valve member, which is oscillated by an electrical modulating rotary actuator with substantially constant velocity in a valve housing or manifold, wherein the valve housing or manifold comprises a main channel, a control channel and measuring channels, the valve member including a cylindrical piston member with a side recess which is adjusted in shape in accordance with a desired control characteristic of the control valve, and the electrical modulating rotary actuator executes oscillating or swinging movements between predetermined angular extreme positions of the valve member.

9. A control valve according to claim 8, wherein the side recess of the cylindrical member is triangular with a pointed end positioned in a horizontal position along a transverse axis.

10. A control valve according to claim 9, wherein the cylindrical member includes a longitudinal central channel with a circular cross section, with the longitudinal central channel being connected with the side recess.

11. A control valve according to claim 8, wherein the recess of the cylindrical member includes parallel sides disposed at a distance from each other and extending perpendicular to a center plane through the cylindrical member.

12. A control valve according to claim 8, wherein the electrical modulating rotary actuator executes oscillating or swinging movements between extreme points with a mutual angular difference of about 90°-180°.

13. A control valve according to claim 9, wherein the electrical modulating rotary actuator executes oscillating or swinging movements between extreme points with a mutual angular difference of about 90°-180°.

14. A control valve according to claim 10, wherein the electrical modulating rotary actuator executes oscillating or swinging movements between extreme points with a mutual angular difference of about 90°-180°.

15. A control valve according to claim 11, wherein the electrical modulating rotary actuator executes oscillating or swinging movements between extreme points with a mutual angular difference of about 90°-180°.

16. A control valve according to claim 8, wherein the electrical modulating rotary actuator executes oscillating or swinging movements between extreme points with a mutual angular difference of about 90°.

17. A control valve according to claim 9, wherein the electrical modulating rotary actuator executes oscillating or swinging movements between extreme points with a mutual angular difference of about 90°.

18. A control valve according to claim 10, wherein the electrical modulating rotary actuator executes oscillating or swinging movements between extreme points with a mutual angular difference of about 90°.

19. A control valve according to claim 11, wherein the electrical modulating rotary actuator executes oscillating or swinging movements between extreme points with a mutual angular difference of about 90°.

20. A control valve according to claim 8, wherein the electrical modulating rotary actuator executes oscillating or swinging movements between extreme points with a mutual angular difference of about 180°.

21. A control valve according to claim 9, wherein the electrical modulating rotary actuator executes oscillating or swinging movements between extreme points with a mutual angular difference of about 180°.

22. A control valve according to claim 10, wherein the electrical modulating rotary actuator executes oscillating or swinging movements between extreme points with a mutual angular difference of about 180°.

23. A control valve according to claim 11, wherein the electrical modulating rotary actuator executes oscillating or swinging movements between extreme points with a mutual angular difference of about 180°.
